(19) United States
(12) Patent Application Publication
(10) Pub. No.: US 2017/0324774 A1
(43) Pub. Date: Nov. 9, 2017

(54) ADDING SUPPLEMENTAL DATA TO A SECURITY-RELATED QUERY

(71) Applicant: Javelin Networks, Inc., Palo Alto, CA (US)

(72) Inventors: Almog Ohayon, Tel Aviv (IL); Guy Franco, Tel Aviv (IL); Roi Abutbul, Be'er Sheva (IL)

(21) Appl. No.: 15/654,425

(22) Filed: Jul. 19, 2017

Related U.S. Application Data
(63) Continuation-in-part of application No. 15/649,512, filed on Jul. 13, 2017.
Application No. 15/649,512 is a continuation-in-part of application No. 15/637,765, filed on Jun. 29, 2017.
Application No. 15/637,765 is a continuation of application No. 15/588,280, filed on May 5, 2017.
(60) Provisional application No. 62/364,010, filed on Jul. 19, 2016.
(60) Provisional application No. 62/361,660, filed on Jul. 13, 2016.
(60) Provisional application No. 62/356,391, filed on Jun. 29, 2016.
(60) Provisional application No. 62/332,264, filed on May 5, 2016.

(51) Int. Cl. H04L 29/06

(52) U.S. Cl. CPC H04L 63/1466; H04L 63/10

(57) ABSTRACT

Various embodiments are described herein that add supplemental data into security-related query results delivered to an operating system. More specifically, an operating system can submit a security-related query to a directory server (or some other network-accessible database), and then pass results of the security-related query to a local proxy. The local proxy can add supplemental data into the results. For example, the local proxy could add bogus directory information in an effort to obfuscate an attempt to gain access to network data by an unauthorized entity who attempts to penetrate the network by parsing the results of the security-related query.

### CROSS-REFERENCE TO RELATED APPLICATIONS

This application claims priority to U.S. Provisional Application No. 62/364,010, entitled “Adding Supplemental Data to a Security-Related Query,” and filed Jul. 19, 2016. This application, is a continuation-in-part of U.S. patent application Ser. No. 15/649,512, entitled “Injecting Supplemental Data into Data Queries at Network End-points,” and filed Jul. 13, 2017, which claims priority to U.S. Provisional Application No. 62/361,660, entitled “Injecting Supplemental Data into Data Queries at Network End-Points,” and filed Jul. 13, 2016. This application is also a continuation-in-part of U.S. patent application Ser. No. 15/637,765, entitled “Artificial Intelligence (AI) Techniques for Learning and Modeling Internal Networks,” and filed on Jun. 29, 2017, which claims priority to U.S. Provisional Application No. 62/356,391, entitled “Artificial Intelligence (AI) Techniques for Learning and Modeling Internal Networks,” and filed on Jun. 29, 2016. This application is also a continuation-in-part of U.S. patent application Ser. No. 15/588,280, entitled “Creation of Fictitious Identities to Obfuscate Hacking of Internal Networks,” and filed May 5, 2017, which claims priority to U.S. Provisional Application No. 62/332,264, entitled “Creation of Ambiguous Identities to Obfuscate Hacking of Internal Networks,” and filed May 5, 2016. The content of the above-identified applications are incorporated herein by reference in their entirety.

### FIELD OF THE INVENTION

Various embodiments described below concern computer-implemented security techniques and, more specifically, adding supplemental data to a response to a security-related query, e.g., to help detect unauthorized access to a network.

### BACKGROUND

A computer network (also referred to simply as a “network”) is a collection of hardware components and computing devices that are interconnected by communication channels that allow data and resources to be shared. Home networks (e.g., Local Area Networks or LANs) are typically used for communication between computing devices installed or used in a home, such as printers, tablets, and mobile phones. Enterprise networks, meanwhile, normally enable employees to access vital programs and data that are necessary for the day-to-day operations of an enterprise (e.g., a company).

However, enterprise networks are often an attractive target for unauthorized parties or entities (also referred to as “hackers”) and need to be protected. Examples of hackers include individuals who attempt unauthorized access to a network, e.g., via malicious software (“malware”) that an individual attempts to cause to spread to one or more of the computing devices in the enterprise network. Each network computing device, such as an end point device or a server, creates a potential entry point for security threats.

### BRIEF DESCRIPTION OF THE DRAWINGS

While the accompanying drawings include illustrations of various embodiments, the drawings are not intended to limit the claimed subject matter.

FIG. 1 is a generalized illustration of an internal (e.g., enterprise) network.

FIG. 2 is a generalized illustration of the internal network after a security application, such as deception module, is installed on a computing device in the internal network.

FIG. 3A depicts a process by which a computing device on a network may add supplemental data into a response to a security-related query.

FIG. 3B depicts a process by which a local proxy can detect malicious acts by monitoring whether an unauthorized party (e.g., a hacker) attempts to use any of the added supplemental data.

FIG. 4 depicts a flow diagram of a first process for adding supplemental data into results of a security-related query to a security-related computer system.

FIG. 5 depicts a flow diagram of a second process for adding supplemental data into the results of a security-related query to a security-related computer system.

FIG. 6 is a block diagram illustrating an example of a computer system in which at least some operations described herein can be implemented.

The drawings depict various embodiments described throughout the Detailed Description for the purposes of illustration only. While specific embodiments have been shown by way of example in the drawings and are described in detail below, the disclosure is amenable to various modifications and alternative forms. The intention is not to limit the disclosure to the particular embodiments described. Accordingly, the claimed subject matter is intended to cover all modifications, equivalents, and alternatives falling within the scope of the disclosure as defined by the appended claims.

### DETAILED DESCRIPTION

Various embodiments are described herein that relate to security techniques for internal (e.g., enterprise) networks and systems that are accessible only to a limited set of authorized users (e.g., employees of the enterprise). More specifically, various embodiments concern adding supplemental data (e.g., false information, such as bogus directory information) into the results of a security-related query, such as a directory enumeration query, at a computing device on a network. For example, the operating system of a server could be modified to change its default behavior for a directory enumeration query.

A directory enumeration query can be used by malicious hackers to locate internal and/or external DNS servers which include directory structures, usernames and information on groups, shares, and services of networked computers. A network enumerator or network scanner is a computer program which can perform direction enumeration queries. This type of program scans networks for vulnerabilities in the security of that network. If there is a vulnerability with the security of the network, it can send a report back to the hacker who may use this information to exploit that network glitch to gain entry to the network or for other malicious activities.

Malicious hackers can, on entry of the network, get to security-sensitive information or corrupt the network, thereby making it useless. If the described network belonged to a company that used the network on a regular basis, the company would lose the function to send information internally to other departments.

The information obtained can be used by an attacker to gain information about the network such as host addresses, server names, directory information, etc. Information can be gathered by standard record enumeration, cache snooping, zone walking, Google® lookup, zone transfer, etc. The gathered information can be used to attack the web application, for example, through brute force.

In at least one embodiment, a technique can be used to inject supplemental data (e.g., false information, such as bogus user account information) into the results of a data query, such as a user account enumeration query, at a computing device on a network. In some embodiments, bogus data is added to a response to a security-related query, such as a directory enumeration query, made of a security-related server, such as an Active Directory server. The directory enumeration query can be made via a Lightweight Directory Access Protocol (LDAP), among others. The bogus data can include, for example, bogus directory data, bogus file data, bogus user account data, etc. If a hacker attempts to breach the security of the network by use of a security-related query, such as by intercepting a response to an Active Directory, LDAP, etc., query, the hacker will likely obtain bogus data. If the hacker attempts to access the network or data of the network by use of the bogus data, a component of the network can detect an access attempt by use of the bogus data, and can determine that an attempted security breach is in progress. Once the attempted security breach is detected, various agents on the network can take security measures to prevent the attempted security breach from turning into an actual security breach.

In an example, the operating system of a server on a network forwards a directory enumeration query to a directory server, such as an Active Directory server, which returns a query response. The default behavior of the operating system can be modified so that the operating system diverts the query response to a local proxy, rather than return the query response directly to the server. The local proxy can then supplement the query response data with additional information before returning the query results to the operating system of the server. For example, the local proxy could add false information (e.g., bogus directory, file, user account, etc., information) that is intended to obfuscate a party (e.g., a hacker) that subsequently reviews the modified query results. Such action may be used as part of a technique for securing the network.

In some embodiments, additional security protections (also referred to as “security layers”) can be implemented by the local proxy for detecting unpermitted and/or malicious conduct of an unauthorized party (e.g., a hacker). A query response can be provided, and the query response can be manipulated by the local proxy. An unauthorized party can be identified by the use of supplemental data (i.e., fictitious or false data). The unauthorized party (e.g., a hacker) may attempt to use one of the deceptive computer elements introduced by the local proxy into the query response. For example, if a server receives a query attempt to access fictitious data, the source of the query can be identified as a hacker. The operating system of the server can be configured to automatically create a Domain Name System (DNS) query in response to determining the unauthorized party has attempted to use a deceptive computer element and then transmit the DNS query to a DNS server. If the DNS server returns a DNS response that includes a failure header, the DNS response can be redirected to the local proxy, which determines whether the sought-after computer element was one of the deceptive elements created by the local proxy. If so, the local proxy can create a record of the event failure that is subsequently analyzed.

Note that such a technique could make use of some security protocols that are already executed by the operating system of the server and not enabled by the local proxy (e.g., the server may already be configured to automatically create the failure event in response to determining the sought-after element does not exist). Moreover, while reference may be made to certain network end points in various examples (e.g., a server), one skilled in the art will recognize that the techniques described herein are equally applicable to other network end points.

Techniques such as those discussed above may be used to protect an internal network from both external and internal attacks (e.g., as part of a proprietary deception technique developed for a particular environment, such as a Microsoft® Windows® operating system, Apple OS® X operating system, or Linux-based operating system). For example, because a hacker may not be able to distinguish between an original query response and the supplemental data, any further attempt by the hacker to access network data using the supplemental data (e.g., a bogus directory or file name) can be screened and flagged for security administrators. Oftentimes, such techniques will be tailored for one or more particular environments. However, some elements of the techniques are transferrable across different environments, types of internal networks, network topologies, etc.

Various embodiments are described herein with reference to system configurations or networks for enterprises (e.g., companies) for convenience. However, one skilled in the art will recognize that features described herein are equally applicable to other system configurations, network types, etc. Moreover, the techniques introduced herein can be embodied as special-purpose hardware (e.g., circuitry), programmable circuitry appropriately programmed with software and/or firmware, or as a combination of special-purpose hardware and programmable circuitry. Hence, embodiments may include a machine-readable medium having stored thereon instructions which may be used to program a computer (or some other computing device) to perform a process. The machine-readable medium may include, but is not limited to, floppy diskettes, optical disks, compact disk read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### Terminology

Brief definitions of terms, abbreviations, and phrases used throughout this application are given below.

References in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

The term “cause” and variations thereof broadly refer to either direct causation or indirect causation. For example, a computer system can “cause” an action by sending a message to a second computer system that commands, requests, or prompts the second computer system to perform the action. Any number of intermediary devices may examine and/or relay the message during this process. In this regard, a device can “cause” an action even though it may not be known to the device whether the action will ultimately be executed.

Any references to sending or transmitting a message, signal, etc., to another device (recipient device) broadly means that the message is sent with the intention that its information content ultimately be delivered to the recipient device; hence, such references do not mean that the message must be sent directly to the recipient device. That is, unless stated otherwise, there can be one or more intermediary entities that receive and forward the message/signal, either “as is” or in modified form, prior to its delivery to the recipient device. This clarification also applies to any references herein to receiving a message/signal from another device; i.e., direct point-to-point communication is not required unless stated otherwise herein.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example, using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, and special significance is not to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to the various embodiments given in this specification.

### System Topology Overview

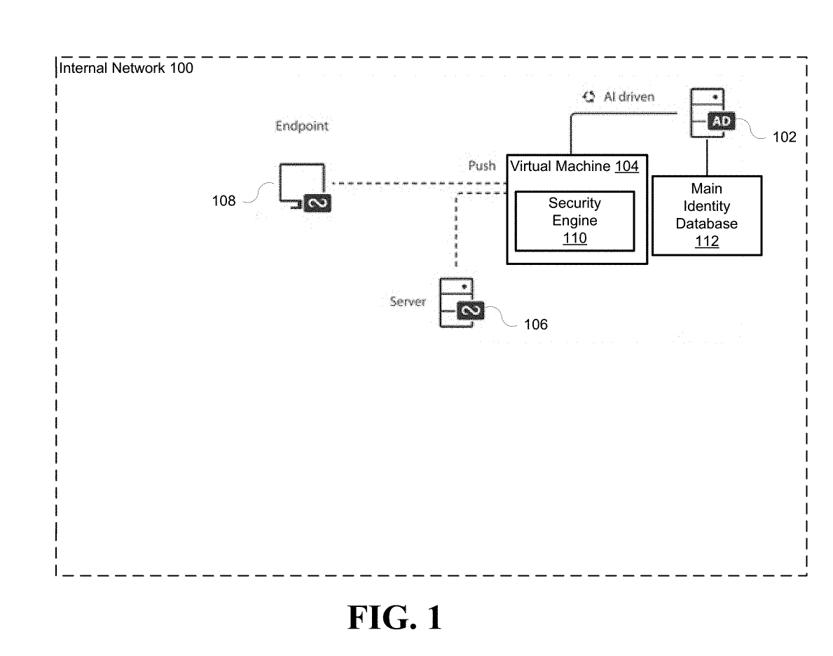

FIG. 1 is a generalized illustration of an internal (e.g., enterprise) network 100. In some embodiments, the internal network 100 is accessible only to a limited set of authorized users (e.g., employees of the enterprise), each of whom has at least one valid identity stored on a directory server 102. More specifically, the directory server 102 (which may be associated with the enterprise) can include a directory data store, a main identity database 112, etc., that is used to facilitate a directory service for the internal network 100. For example, the directory server 102 could be an Active Directory (AD) server if the internal network 100 is a Microsoft® Windows® network. The directory server 102 (and, more specifically, the directory data store, the main identity database, etc.) is accessible to computer devices that include servers 106 and end point 108 that reside within the internal network 100. The directory server 102 can include all directory information, identities for all authorized users of the internal network 100, etc., and thus is able to supply directory and file information, user account information, etc., in response to a query. Directory, file, and user account information queries are examples of security-related queries. A computer that receives such a query is an example of a security-related computer.

The directory server 102 is accessible to a virtual machine 104 that includes one or more security programs/routines for creating supplemental data for the internal network 100. The virtual machine 104 can read elements (e.g., computer, directory, file, and users' metadata, etc.) from the directory data store or main identity databases 112 of the directory server 102 in order to create the supplemental data for the internal network 100. The directory data store and main identity databases 112 are generally left unchanged (i.e., the virtual machine 104 uses the directory data store and main identity databases as read-only elements for modeling).

In some embodiments, the modeling is driven by a security engine 108 that learns the characteristics of the internal network 100. The security engine 108 can then create new fictitious identities using the AI algorithm(s) that take into account the syntax of the valid identities stored in the main identity database 112. The security engine can model the network elements (e.g., directories and files and their associated security-related information) and create supplemental data. The supplemental data may include false information, such as bogus directories, files, etc., that can then be installed/added into computing devices (e.g., server 106 and end point 108) that reside within the internal network 100.

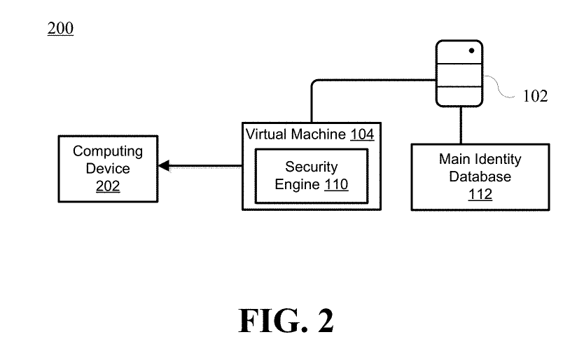

FIG. 2 is a generalized illustration of an internal (e.g., enterprise) network 200 after a security application, such as a deception module, is installed on a computing device 202 in the internal network. Performance may require, for example, that the security engine 110 install a security program or routine. A service external to the computing device 202, such as the virtual machine 104, can physically or virtually install the deception module on the computing device.

The deception module may cause changes to the process in the operating system of the computing device that responds to directory enumeration queries or user account enumeration query, along with any supplemental data manufactured by the external service. The supplemental data may include false information such as bogus directory, file, user account information, etc. In some cases, the operating system of the computing device will have read-only access to the supplemental data. Fictitious identities, fictitious directories, and/or supplemental data may be modeled based on valid data such as characteristics of naming conventions discovered through a parsing of the main identity database 112 and/or directory information maintained by a directory server of the internal network 200.

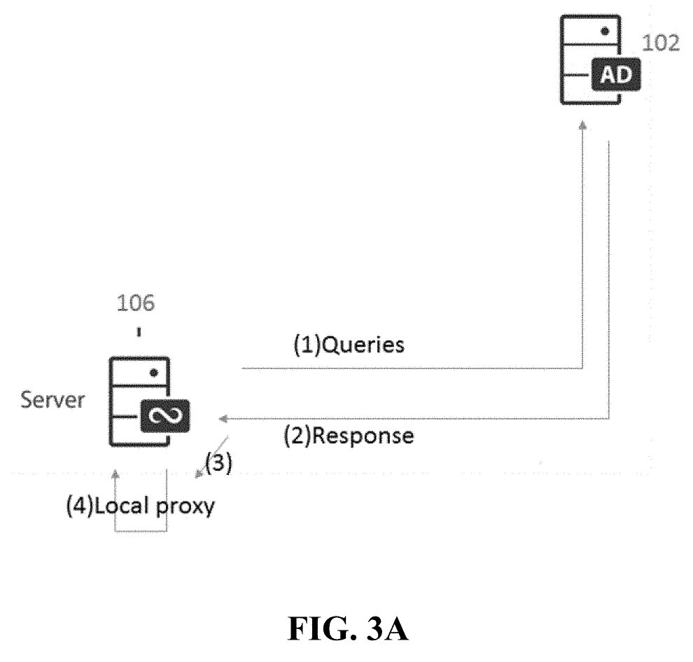

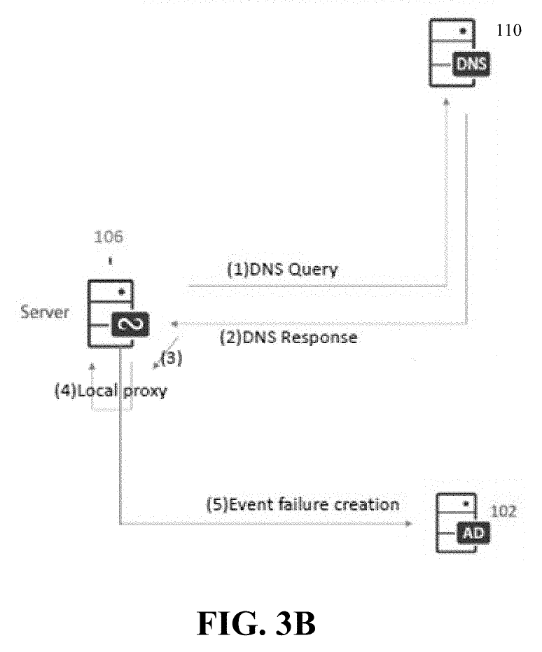

FIG. 3A depicts a process by which a computing device on a network, such as a server 106, may add supplemental data into a response to a security-related query. The server 106 may initially send the security-related query, such as a directory enumeration query, over to the directory server 102, such as via an LDAP query. When the directory server 102 responds, such as via an LDAP response, the operating system of the server 106 may direct the response to the deception module (e.g., a local proxy). The local proxy can add the supplemental data that may include false information to the response, and then send the modified response back to the operating system of the computing device.

If the internal network is a Microsoft® Windows®-based network, a directory enumeration query can be processed by a Directory Enumeration process. The Directory Enumeration process may be implemented using Dynamic Link Libraries (DLLs), Application Programming Interfaces (APIs), etc., specific to a Microsoft® Windows®-based operating system. The Directory Enumeration process may use a network protocol, such as Lightweight Directory Access Protocol (LDAP) protocol hosted by Transmission Control Protocol (TCP), to communicate the query to an Active Directory (AD) server. The response from the AD server may be redirected to a local proxy that adds supplemental data into the response generated by the AD server. The supplemental data may include any type of supplemental information (e.g., false information such as bogus directories or files).

The supplemental information can be generated to appear similar to the valid directory structure. In some embodiments, a machine learning algorithm can determine the format for the directory names, folder names, file names, and directory structure. The algorithm can determine the format including the pattern of alphanumeric and symbols. For example, the machine learning algorithm can determine that an underscore is commonly used in the valid directories between words (e.g., user_files, program_files, etc.). In another example, it can be determined that the letter “o” and number zero are not used in the naming convention. In at least one example, it can be determined that the directory names are of a specific length or specific range of length (e.g., 6-9 characters, etc.).

The supplemental data can be generated to match the format of the valid data. The individual valid records can be analyzed to determine the format of the valid data. For example, if it is determined that each directory ends with a number, then the generated supplemental data can also be generated to end with a number. In at least one embodiment, the supplemental data is generated by copying a directory name and editing one character. In an embodiment, if a valid directory name is tom_photos, the supplemental data can be created as tim_photos. In at least one embodiment, in choosing which character to change, the format is analyzed, and it is determined whether the result of changing the one character would still follow the determined format. For example, it can be determined that the result of changing the “o” in tom to an “i” would follow the determined format but changing the “_” to “a” would not. In at least one embodiment, the supplemental data can be matched to the determined format. The machine learning algorithm can also be used to determine folder names and file names.

The directory structure can also be analyzed and used to generate supplemental data. For example, the number and/or range of subfolders can be determined, and the supplemental data can include the determined number and/or range of supplemental data subfolders. In some embodiments, the valid and supplemental data can be stored in the same location. The supplemental data records can appear identical to valid records of the valid data. In some embodiments, the supplemental data can be flagged as supplemental date so it can be identified by the authorized users but not the unauthorized users.

FIG. 3B depicts a process by which a local proxy can detect malicious acts by monitoring whether an unauthorized party (e.g., a hacker) attempts to use any of the added supplemental data. Additional security protections (also referred to as “security layers”) can be implemented by the local proxy for detecting unpermitted and/or malicious conduct of the unauthorized party.

More specifically, after the response to the security-related query has been manipulated (e.g., by the local proxy), the unauthorized party may attempt to use some or all of the supplemental data added into the response. For example, the unauthorized party could attempt to access network data using a deceptive computer element (e.g., false information, such as a bogus directory name) introduced by the local proxy into the response.

In response to determining that the unauthorized party has attempted to use the supplemental data, the operating system of the server can automatically create a Domain Name System (DNS) query and transmit the DNS query to a DNS server. The DNS server 110 creates and returns a DNS response that includes a failure header when the DNS server 110 determines that the DNS query cannot be satisfied. In response to determining that the DNS response includes a failure header, the DNS response can be redirected to the local proxy, which determines whether the sought-after information included supplemental data that was added into the response. If so, the local proxy can create a record of the event failure that can be subsequently analyzed.

Such a technique could make use of some security protocols that are already executed by the operating system of the server. For example, the server may already be configured to automatically create the failure event in response to determining the sought-after information does not actually exist. Moreover, while reference may be made above to a server, one skilled in the art will recognize that the techniques described herein are equally applicable to other network end points.

In at least one embodiment, the hacker is permitted to access fictitious directories and files. The fictitious directories can be stored on a separate one or more servers. The fictitious directories and files can be stored in a location uniquely designed for hackers. The locations (i.e., sandbox, etc.) storing the fictitious data can be monitored to gain insight into the behavior of the hacker. The sandbox can be implemented by creating an environment that mimics and/or replicates the targeted environment. Monitored behavior can include directories accessed by the hacker, information about queries attempted by the hacker, information about the hacker such as operating system and IP address, etc. For example, if a hacker attempts to access the fictitious directory, the request can be forwarded to a sandbox where the hacker can be given access to only the fictitious data, and the hacker's behavior can be monitored. In at least one embodiment, the sandbox can be configured to not contain valid data. In some embodiments, the sandbox can be configured to not contain private valid data but can contain valid data which can be shared with the hacker.

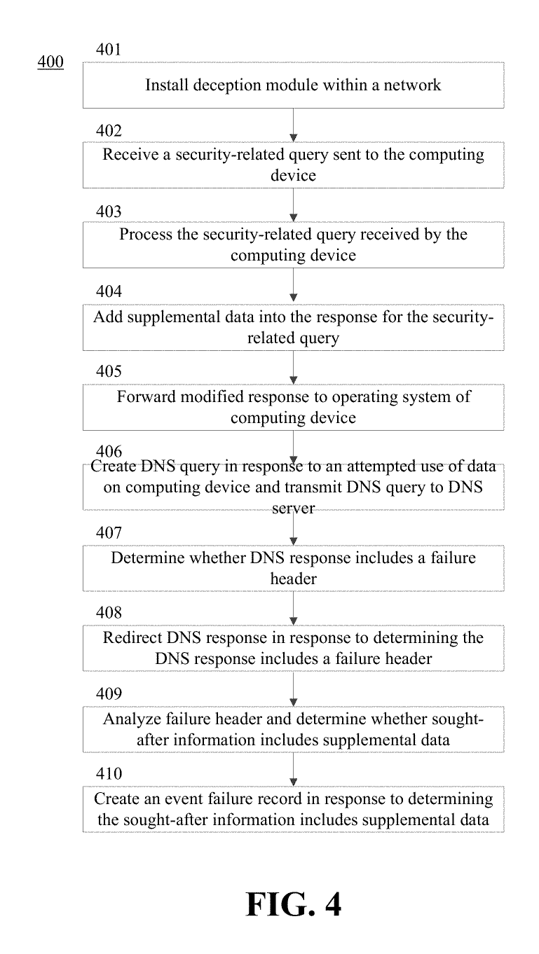

FIG. 4 depicts a flow diagram of a process 400 at a network computing device for the addition of supplemental data into the results of a security-related query, such as a directory enumeration query. Initially, a deception module is installed within a network (step 401). The deception module could be included on a virtual machine that is installed, for example, on a computing device (e.g., a server or end point) that resides within the network. More specifically, installation of the deception module may require that modifications be made to the operating system installed on the network computing device. The computing device can then receive a security-related query, such as a directory enumeration query (step 402).

The computing device will then process the security-related query and may perform a system operation (step 403). For example, the computing device may read information from a directory server in response to receiving a directory enumeration query. Next, the operating system of the network computing device directs the response to the deception module (e.g., a local proxy). The deception module could then add supplemental data to the response generated by the directory server (step 404). The supplemental data may include false information (i.e., information not provided by the directory server), such as bogus directory or file information. The deception module then forwards the modified response back to the operating system of the network computing device for further processing (step 405). The addition of the supplemental data may not infringe upon the composition of the network as a whole or the ability of authorized users to continue legitimate use of the network. The security techniques described herein may be entirely or substantially unobservable/unnoticeable to authorized users of the internal network (e.g., employees of an enterprise).

As noted above, this technique could be used as part of a larger system to obfuscate hacking of the internal network. For example, the computing device and/or the deception module may subsequently track whether the supplemental data is used in an attempt to access the internal network. More specifically, the operating system of the computing device can automatically create a DNS query responsive to determining that a user has attempted to use data hosted by the computing device, and transmit the DNS query to a DNS server (step 406).

The computing device will subsequently receive a DNS response from the DNS header. If the DNS query includes a request for supplemental data added by the local proxy, the DNS response will include a failure header generated by the DNS server. Said another way, the DNS response will include a failure header when the DNS server determines that the DNS query cannot be satisfied because it includes a request for deceptive (e.g., non-authentic) data. Thus, after transmitting a DNS query to the DNS server, the operating system of the computing device can determine whether the DNS response includes a failure header (step 407).

In some embodiments, the DNS response can be redirected to the deception module for further analysis (step 408). In at least one embodiment, the DNS response can be redirected to the deception module for further analysis (step 408) if a failure header is identified. The deception module can analyze the failure header and determine whether the sought-after information includes supplemental data (step 409). If the DNS request was for supplemental data, the local proxy can create a record of the event failure that can be subsequently analyzed (step 410). For example, event failure records can be used to identify whether the internal network is an attractive target for unauthorized parties, which network end point(s) have been targeted most often, which directory or file data has been targeted most often, which preventive measure(s) should be employed by the deception module, etc.

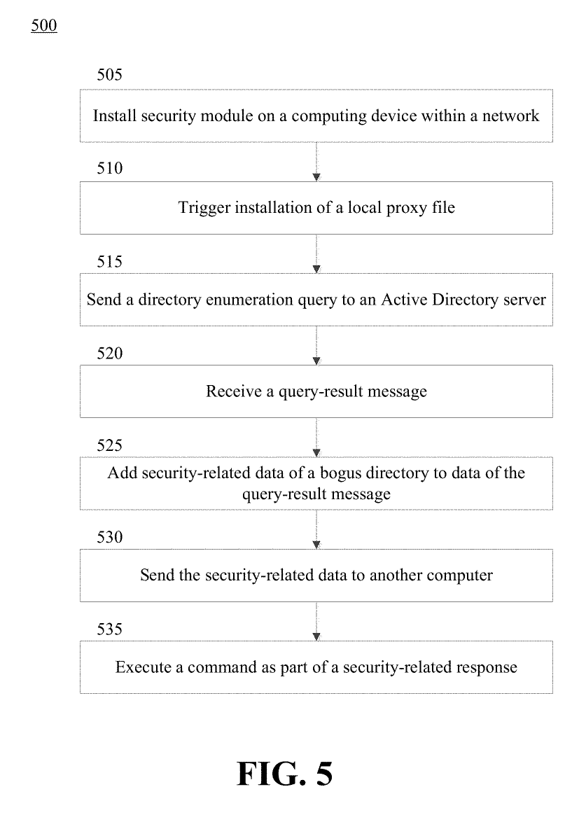

FIG. 5 depicts a flow diagram of a process for adding supplemental data to a security-related query to a security-related computer system. At block 505, a computing device of a network, such as end point 108 of network 100 of FIG. 1, installs a security application/feature/add-on/etc., such as a deception module. The installation can be initiated or triggered by the computing device, by a directory server of the network, or by any other computer on the network. The security application/feature/add-on/etc. can include a code for a security module, such as virtual machine 104, that includes a security engine 108. Once installed, the security application/feature/add-on/etc. is executed at the computing device, which initiates the security module. The security module subsequently triggers generation of security-related data at the computing device, such as by: (block 510) triggering installation of a local proxy file; triggering generation of an identifier of a bogus element, such as a bogus directory, a bogus file, etc.; triggering generation of data that indicates access privileges of/to a bogus element, such as access privileges to a bogus directory, to a bogus file, etc.; triggering generation of data that indicates that a bogus element exists, etc. The generation of the security-related data can include storing the security-related data in a file, installing a local control file, storing the security-related data in memory of the computer system, etc.

In some embodiments, the computing device is an intermediary device between a query computer and a security-related computer. A user, who in some cases is a hacker attempting to breach the security of the network, can use the query computer to send a security-related query for delivery to the security-related computer. A security-related query can include: a directory enumeration request, which can use the lightweight directory access protocol (LDAP), which utilizes transmission control protocol (TCP); an Active Directory Request; a security accounts management (SAM) enumeration request, which can use the server message block (SMB) protocol, which utilizes TCP; etc.

The computing device, being an intermediary computing device between the query computer and the security-related computer, receives the security-related query. The security module executing at the computing device (block 515) forwards the security-related query, which can be, e.g., an Active Directory Query, a directory enumeration request, etc., to a security-related computer, such as directory server 102 of FIG. 1, which can be an Active Directory server. In some embodiments, the computing device initiates the security-related query, which may have been triggered by a hacker who gained unauthorized access to the computing device, and the computing device (block 515) sends the security-related query to the security-related computer.

At block 520, in response to the security-related query, the security-module, via the computing device, receives a query-result message from the security-related computer. The query-result message includes security-related data, such as: an identifier of an element, such as a directory, a file, etc.; data that indicates data access privileges of/to an element, such as to a directory, to a file, etc.; data that indicates that an element exists; a response to an Active Directory query; etc. The security module executing at the computing device (block 525) adds supplemental data to data of the query-result message. The supplemental data includes deceptive/false/etc. security-related data, such as: an identifier of a bogus element, such as a bogus directory, a bogus file, etc.; data that indicates access privileges of/to a bogus element, such as a bogus directory, a bogus file, etc.; data that indicates that a bogus element exists; etc.

At block 530, the computing device sends the security-related data to another computer. In the example where the hacker utilized the query computer to initiate the security-related query, the computing device sends the security-related data, which includes the supplemental data, to the query computer. In the example where the hacker gains unauthorized access to the computing device, the computing device sends the security-related data to a particular computer that the hacker used to gain unauthorized access to the computing device.

If the hacker has gained access to the security-related data, the hacker may use the security-related data to attempt to gain unauthorized access to the network, such as by gaining unauthorized access to a computer on the network, to data on the network, etc. If the hacker uses the supplemental data, such as information pertaining to a bogus element, to attempt to gain access to data of the network, security-related software running at a target computer can detect that an access attempt used the supplemental data, and can take action to prevent the unauthorized access. For example, if the hacker provides an identifier of a bogus directory/file/etc. in an attempt to access a computer/data/etc., the security-related software, when doing security checks to ensure that the hacker has proper credentials/permissions/etc. to access the computer/data/etc., can detect that the access is based on the bogus directory/file/etc. The security-related software can determine, based on the supplemental data being received by the security-related software as part of the security-related query, that the security-related query is associated with an attempt to breach the security of the network.

At block 535, the computing device executes a command as part of a security-related response to the attempted breach. For example, the computing device can generate and send a notification (e.g., an email, text message, push notification, etc.) to an appropriate entity so that steps can be taken to address the attempted breach. As another example, the computing device can send a message to the computer that is the target of the breach that causes the computer to stop responding to network requests.

### Computer System

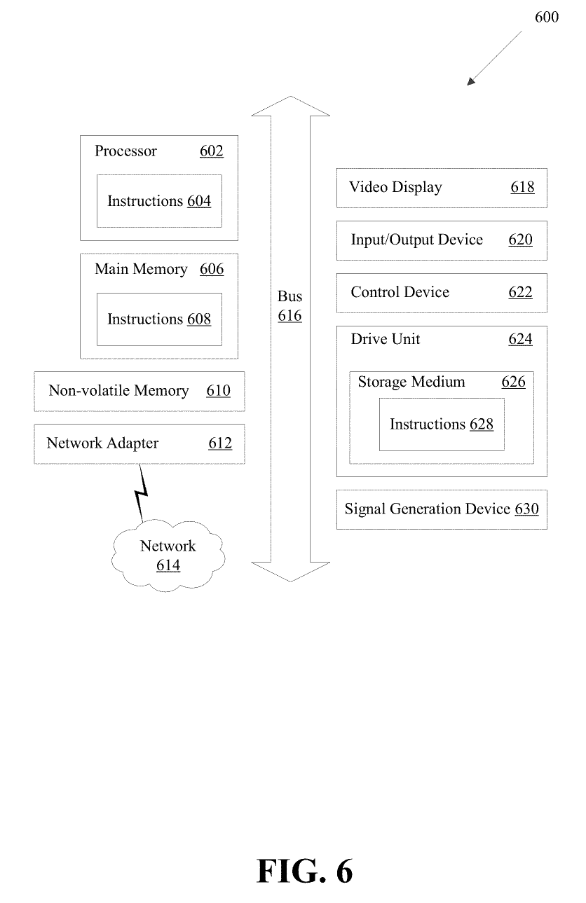

FIG. 6 is a block diagram illustrating an example of a computing system 600 in which at least some operations described herein can be implemented. The computing system may include one or more central processing units (“processors”) 602, main memory 606, non-volatile memory 610, network adapter 612 (e.g., network interfaces), video display 618, input/output devices 620, control device 622 (e.g., keyboard and pointing devices), drive unit 624 including a storage medium 626, and signal generation device 630 that are communicatively connected to a bus 616. The bus 616 is illustrated as an abstraction that represents any one or more separate physical buses, point to point connections, or both, connected by appropriate bridges, adapters, or controllers. The bus 616 can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the computing system 600 operates as a standalone device, although the computing system 600 may be connected (e.g., wired or wirelessly) to other machines. In a networked deployment, the computing system 600 may operate in the capacity of a server or a client machine in a client-server network environment, or as a peer machine in a peer-to-peer (or distributed) network environment.

The computing system 600 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by the computing system.

While the main memory 606, non-volatile memory 610, and storage medium 626 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 628. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 604, 608, 628) set at various times in various memory and storage devices in a computer, and that, when read and executed by one or more processing units or processors 602, cause the computing system 600 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices 610, floppy and other removable disks, hard disk drives, optical disks (e.g., Compact Disk Read-Only Memory (CD ROMS), Digital Versatile Disks, (DVDs)), and transmission type media such as digital and analog communication links.

The network adapter 612 enables the computing system 1000 to mediate data in a network 614 with an entity that is external to the computing device 600, through any known and/or convenient communications protocol supported by the computing system 600 and the external entity. The network adapter 612 can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network adapter 612 can include a firewall which can, in some embodiments, govern and/or manage permission to access/proxy data in a computer network and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can include, but are not limited to, intrusion-prevention, intrusion detection, next-generation firewall, personal firewall, etc.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the disclosure and its practical applications, thereby enabling others skilled in the relevant art to understand the claimed subject matter, the various embodiments, and the various modifications that are suited to the particular uses contemplated.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless those terms are explicitly defined herein. Accordingly, the actual scope of the disclosure encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the disclosure be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A method for detecting unauthorized access to a computer network, the method comprising:
installing, by a computer system at a network, a security application;
executing, by the computer system, the security application, wherein the execution of the security application causes a security-related virtual machine to be initiated at the computer system;
triggering, by the security-related virtual machine, installation of a local proxy file at the computer system, wherein the local proxy file causes security-related data of a bogus directory to be added to data of a response to a directory enumeration query;
sending, by the computer system, the directory enumeration query to a directory server;
receiving, by the computer system and from the directory server, a query-result message that was sent in response to the directory enumeration query;
adding, by the computer system, the security-related data of the bogus directory to data of the query-result message;
sending, by the computer system, the security-related data of the bogus directory to another computer; and
executing, by the computer system, a command as part of a security-related response triggered by a message from the directory server that indicates that the directory server received a security-related query that includes a portion of the security-related data of the bogus directory, and that indicates that the security-related query is part of an attempted breach of security of the network.

2. A method comprising:
executing, by a computer system, a security-related application, wherein the execution of the security-related application causes a security-related virtual machine to be initiated at the computer system;
triggering, by the security-related virtual machine, generation of a local control file at the computer system, wherein the local control file causes supplemental data to be added to data of a response to a security-related query;
sending, by the computer system, the security-related query to a security-related computer system;
receiving, by the computer system and from the security-related computer system, a query-result message that was sent in response to the security-related query;
adding, by the computer system, the supplemental data to data of the query-result message;
sending, by the computer system, the supplemental data to another computer; and
executing, by the computer system, a command as part of a security-related response triggered by a message from the security-related computer system that indicates that the security-related computer system received the security-related query that included a portion of the supplemental data.

3. The method of claim 2,
wherein the local control file includes the supplemental data;
wherein the supplemental data includes an identifier of a bogus directory, a bogus file, or a bogus user account;
wherein the security-related query is an directory query,
wherein the security-related computer system is the computer system that is executing an directory service,
wherein the query-result message was sent in response to the directory query that includes the identifier of the bogus directory, the bogus file, or the bogus user account, and
wherein the portion of the supplemental data is all of the supplemental data.

4. A method comprising:
generating, by a computer system at a network, security-related data at the computer system, wherein the security-related data causes supplemental data to be added to data of a response to a security-related query;
sending, by the computer system, the security-related query to a security-related computer system;
receiving, by the computer system and from the security-related computer system, a query-result message that was sent in response to the security-related query; and
adding, by the computer system, the supplemental data to data of the query-result message.

5. The method of claim 4, wherein the generating of the security-related data includes any of storing the security-related data at a file, installing a local control file, or storing the security-related data in memory of the computer system.

6. The method of claim 4, wherein the supplemental data is the security-related data associated with a bogus directory, a bogus file, or a bogus user account.

7. The method of claim 6, wherein the security-related data is any of: an identifier of the bogus directory, the bogus file, or the bogus user account; data that indicates access permissions of the bogus user account, or that indicates access permissions to the bogus directory or the bogus file, or; data that indicates that the bogus directory, the bogus file, or the bogus user account exists.

8. The method of claim 4, wherein, if the supplemental data is received as part of a particular security-related query sent to the security-related computer system, the supplemental data indicates that the particular security-related query is associated with an attempt to breach security of the network.

9. The method of claim 4, further comprising:
determining, based on the supplemental data being received by the security-related computer system as part of a particular security-related query, that the particular security-related query is associated with an attempt to breach security of the network.

10. The method of claim 4, wherein the supplemental data is the security-related data.

11. The method of claim 4, comprising:
generating the supplemental data, wherein generating the supplemental data includes analyzing valid data.

12. The method of claim 11, wherein analyzing the valid data includes determining a format of a valid record.

13. The method of claim 12, wherein generating the supplemental data includes creating the supplemental data in a similar format as the format of the valid record.

14. A computer-implemented method, the method comprising:
causing a deception module to be installed on a computing device within a network;
receiving, by the computing device, a security-related query;
sending, by the computing device, the security-related query to a directory server that includes network elements;
receiving, by the computing device, a response to the security-related query from the directory server;
adding, by the deception module, supplemental information to the response from the directory server to arrive at a modified query response; and
further processing, by the computing device, the modified query response.

15. The computer-implemented method of claim 14, wherein the computing device is a server or an end point.

16. The computer-implemented method of claim 14, wherein the network is an internal network associated with an enterprise.

17. The computer-implemented method of claim 14, wherein the security-related query is a directory enumeration query, and wherein the supplemental information is bogus directory information.

18. The computer-implemented method of claim 14, wherein the computing device executes a Microsoft Windows operating system, and wherein the deception module includes changes to a Directory Enumeration process of the Microsoft Windows operating system using one or more dynamic-link libraries (DLLs) and one or more application programming interfaces (APIs) associated with the Microsoft Windows operating system.

19. The computer-implemented method of claim 14, comprising:
generating the supplemental information, wherein generating the supplemental information includes analyzing valid data.

20. The computer-implemented method of claim 19, wherein analyzing the valid data includes determining a format of a valid record.

21. The computer-implemented method of claim 20, wherein generating the supplemental information includes creating the supplemental information in a similar format as the format of the valid record.
